(19) United States
(12) Patent Application Publication
(10) Pub. No.: US 2003/0174639 A1
(43) Pub. Date: Sep. 18, 2003

(54) Thin-type optical disc

(75) Inventors: Shyhyeu Wang, Hsinchu Hsien (TW); Tzu-Hao Kuo, Hsinchu Hsien (TW); Fu-Chien Yu, Hsinchu Hsien (TW); Szu-Hsiung Sun, Hsinchu Hsien (TW); Hung-Chi Chien, Hsinchu Hsien (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Ritek Corporation

(21) Appl. No.: 10/265,559

(22) Filed: Oct. 3, 2002

(30) Foreign Application Priority Data
Mar. 12, 2002 (TW) 091104669

(51) Int. Cl. G11B 3/70; G11B 5/84; G11B 7/26

(52) U.S. Cl. 369/289

(57) ABSTRACT

The present invention discloses a thin-type optical disc, which comprises a thin optical disc and an auxiliary adapter. The thickness of the optical disc is smaller than that of the conventional optical disc, so as to save the plastic material used in the production of optical discs. Furthermore, the thin optical disc is necessarily accompanied with the auxiliary adapter of a transparent substrate for reading or writing data. If the thin optical disc is put into a optical disc player or rewriter alone, it will not operate normally. Thus, the behaviors and the rules for reading the thin optical disc can be well managed and controlled.

### BACKGROUND OF THE INVENTION

1. Field of the Invention

The present invention relates to a thin-type optical disc, and more specifically, to a thin optical disc having a thickness less than 1 mm and associated with specialized reading and writing modes.

2. Description of the Related Art

Following the vigorous development of information industries and the rapid growth of multi-media video markets, the developing trend for digital data storage media is heading toward larger capacity and higher density. The optical discs are being widely used in all kinds of digital data storage and reading mediums because of its large storage capacity, higher reliability and easy portability.

Normally, the widely used optical discs are the CD (Compact Disc) family, such as CD-ROM, CD-R (Recordable), CD-RW (Rewritable), etc. The second generation of optical discs are the DVD (Digital Versatile Disc) family, such as DVD-R, DVD-RW, DVD-RAM, etc. As for the next generation of optical discs, like HD-DVD, etc., which is well known in development, and employs the laser light source 405 nm in wavelength, all their specifications are not well defined. The next generation of optical discs will have much larger recording capacities than ever and their thickness is still 1.2 mm in the standard specification of optical discs. FIG. 1(a) is the cross-sectional diagram for a conventional CD of a type of optical discs. A central hole 11 is located in the center of the CD 10. The upper surface of the CD 10 is a printing surface 12 and its lower surface is a readable surface 13. The total thickness of the CD 10 is about 1.2 mm.

FIG. 1(b) is the enlarged structural diagram of portion A in FIG. 1(a). The structure comprises all layers from top to bottom as follows: a printing layer 14, a protection layer (such as a lacquer) 15, a reflection layer 16, data tracks 17 and a PC (Polycarbonate) substrate 18. Such kind of optical discs is a type of CD-ROM. The PC substrate 18 is a transparent plastic material (an index of refraction around 1.5), and a spiral continuous groove is formed on its surface. The reflection layer 16 is uniformly sputtered over the groove by vapor deposition techniques. The laser light from an optical disc player will have refraction after passing through the PC substrate 18. The laser light should be focused around a recording layer after the refraction, such as on the data tracks 17, so as to complete the operation for writing or reading data.

The substrate 18 applied to the optical disc can be made from a suitable plastic material including polyester terephthalate, polyester resin, epoxy resin, acrylic resin, polyvinyl chloride resin, or polystyrene resin. The most commonly used material is polycarbonate. Furthermore, the material also includes newly developed COC (cycloolefin copolymer), etc.

As for recordable optical discs, including all kinds of CD-R, CD-RW, DVD-R, DVD-RW, DVD-RAM, etc., they have an additional multi-layer structure interposed between the reflection layer and the substrate, such as a recording layer, a dielectric layer or other photo layers, overlaid on the reflection layer 16 of the CD 10.

Compared with the CD 10, which is made of a single layer of the PC substrate 18, the digital versatile disc (DVD) 20 is, composed of two PC substrate layers with the same total thickness. FIG. 2(a) is the cross-sectional diagram of a conventional digital versatile disc, which is a type of DVD-5. The digital versatile disc 20 also has a central hole 21, a printing surface 22 and a readable surface 23 with the same total thickness 1.2 mm as the CD 10.

FIG. 2(b) is the enlarged structural diagram of the portion B as shown in FIG. 2(a). The structure comprises all layers from top to bottom as follows: a printing layer 24, a first PC substrate 25, an adhesive layer 26, a reflection layer 27, data tracks 28 and a second PC substrate 29. The digital versatile disc 20 has the first PC substrate 25 as a dummy layer (0.6 mm in thickness).

The general optical disc rewriter and player can accept an optical disc from 1.0 to 1.6 mm in total thickness. The major thickness of the optical disc consists of the PC substrate layer, and the total thickness of the other layers is rather small, at most several hundredths micrometers. Thus, it is an important issue to reduce the thickness of the PC substrate layer of the optical disc and satisfy the readable requirement of the optical disc player in optics.

### SUMMARY OF THE INVENTION

The main object of the present invention is to provide an optical disc less than 1 mm in total thickness, which can save the material cost for the production of optical discs.

The second object of the present invention is to provide a thin-type optical disc to protect storage data against illegal or unallowable uses, so that behaviors and users of data reading and writing can be well managed and controlled.

The third object of the present invention is to provide an optical disc that is apt to carry, deliver and store due to the shrinkage of optical discs in volume.

To this end, the present invention discloses a thin-type optical disc comprising an optical disc less than 1 mm in thickness. The optical disc does not operate normally if directly put in a conventional optical disc rewriter and player. The present invention is characterized in further comprising a transparent substrate that the thin optical disc must be used with the transparent substrate to complete the operation of data reading and writing. The transparent substrate may be an auxiliary adapter. The auxiliary adapter is stacked under the readable surface of the thin optical disc, and may also be fixed before the objective lens of the pick-up head in an optical disc player in order to correctly focus the laser beam from the pick-up head on data tracks.

### BRIEF DESCRIPTION OF THE DRAWINGS

The invention will be described according to the appended drawings, in which:

FIG. 1(a) is the cross-sectional diagram of a conventional CD;

FIG. 2(b) is the enlarged structural diagram of the portion A in FIG. 1(a);

FIG. 2(a) is the cross-sectional diagram of a conventional digital versatile disc;

FIG. 2(b) is the enlarged structural diagram of the portion B in FIG. 2(a);

FIG. 3 is the schematic diagram of data reading and writing of a conventional CD in optics;

FIG. 4(a) is the cross-sectional diagram of the optical disc in accordance with the present invention;

FIG. 4(b) is the cross-sectional diagram of the auxiliary adapter in accordance with the present invention;

FIG. 5 is the schematic diagram of the thin-type optical disc in accordance with one preferred embodiment of the invention;

FIG. 6(a) is the cross-sectional diagram of the optical disc in accordance with the present invention;

FIG. 6(b) is the cross-sectional diagram of the auxiliary adapter in accordance with the present invention;

FIG. 7 is the schematic diagram of the thin-type optical disc in accordance with further preferred embodiment of the invention;

FIG. 8(a) is the cross-sectional diagram of the optical disc in accordance with the present invention;

FIG. 8(b) is the cross-sectional diagram of the auxiliary adapter in accordance with the present invention;

FIG. 9 is the schematic diagram of the thin-type optical disc in accordance with another preferred embodiment of the invention.

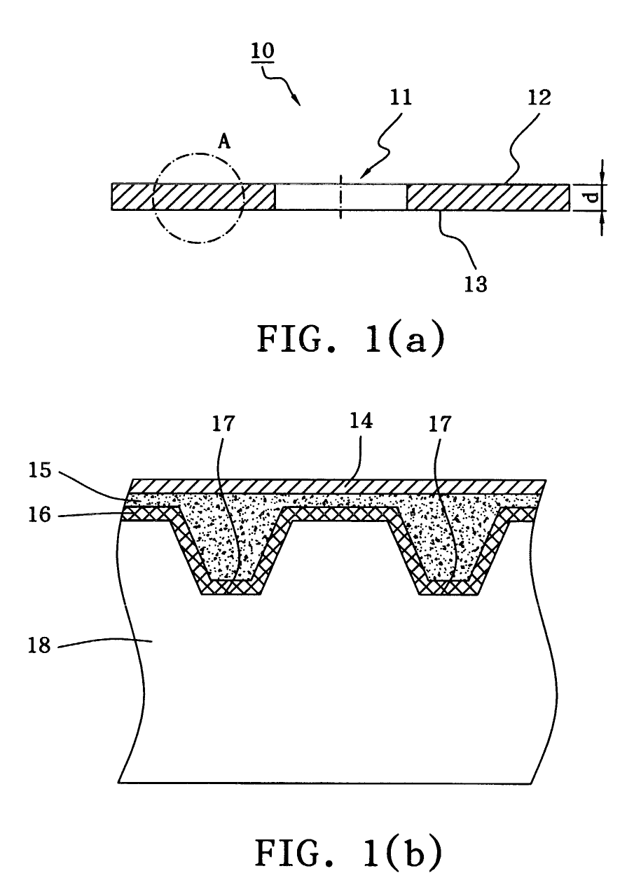

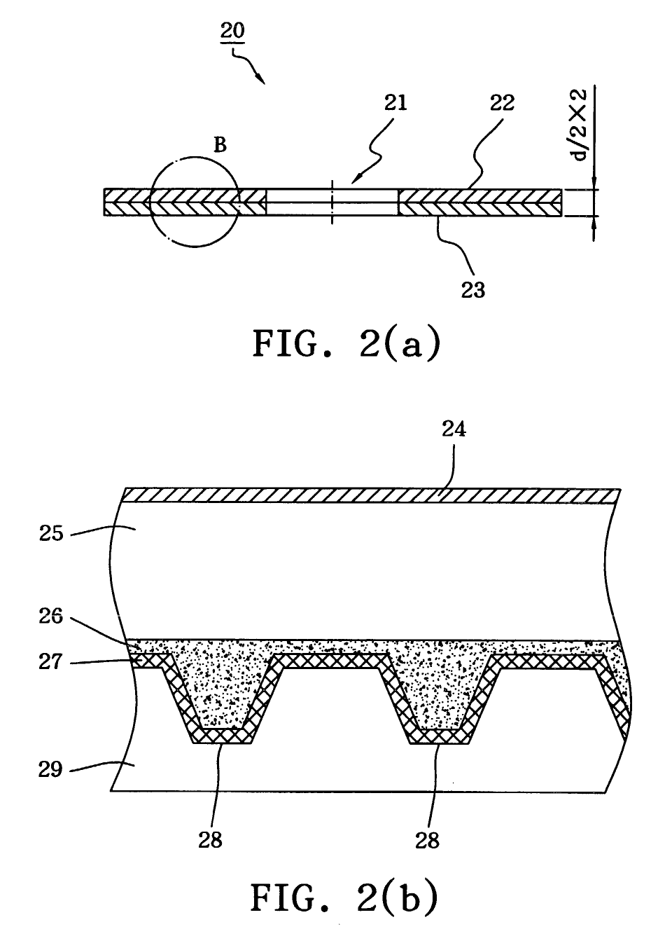

### PREFERRED EMBODIMENT OF THE PRESENT INVENTION

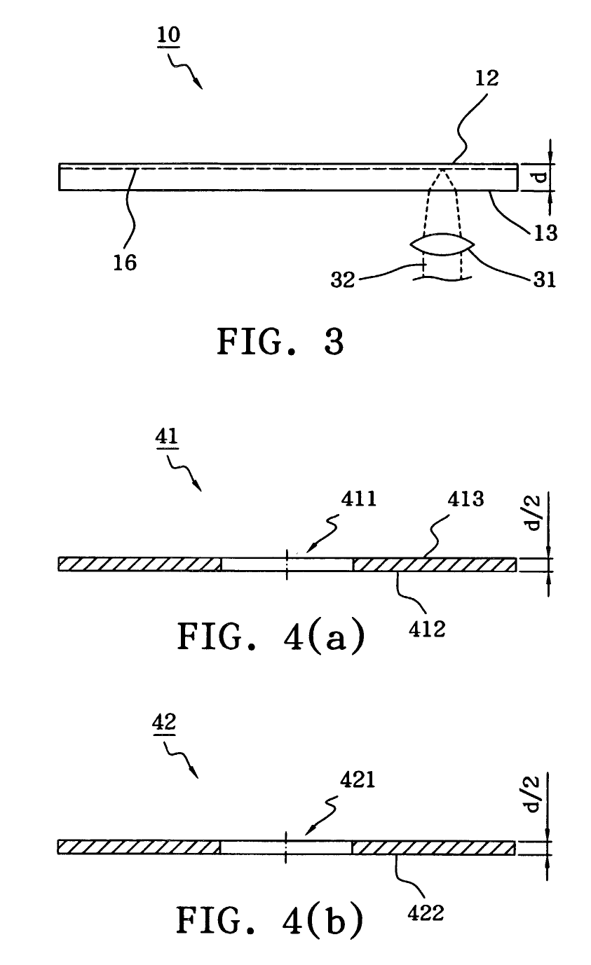

In an example of CD-ROM of a kind of CD as shown in FIG. 3, the mode of data reading and writing applied to the CD 10 in optics is that a laser beam 32 is focused after passing through an object lens 31 and then entering the PC substrate of a CD 10. The laser beam 32 has refraction phenomena on the surface of the PC substrate 13, and is again focused on the data reading layer, such as data tracks 17.

FIG. 4(a) is the cross-sectional diagram of the optical disc in accordance with the present invention, wherein it is an embodiment relating to the modification of conventional CD. An optical disc 41 is only about 0.6 mm in thickness, that is, the thickness of the PC substrate of a composed layer in the optical disc 41 is reduced to a half of that of conventional CD. There is a further element of an auxiliary adapter 42 with a similar shape as the optical disc 41, which is also 0.6 mm in thickness, as shown in FIG. 4(b). The auxiliary adapter 42 is made of a transparent substrate, wherein the PC (polycarbonate) is a preferred raw material for production.

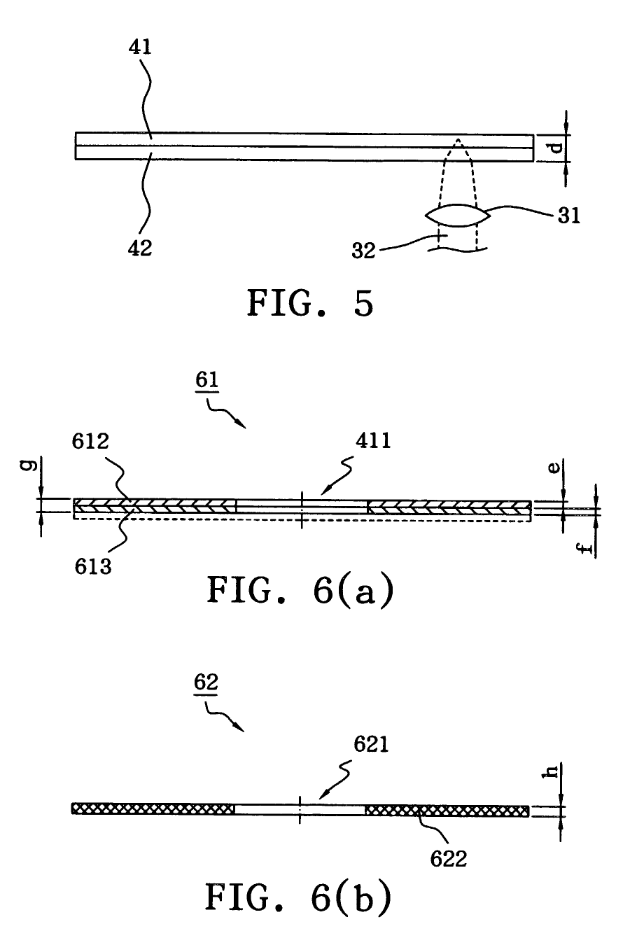

As shown in FIG. 5, the readable surface 412 of the optical disc 41 is stacked on the upper surface of the auxiliary adapter 42, and both of them are put in the loading and unloading mechanism of a optical disc player (not shown). After stopping at the right playing position of the optical disc player, a laser beam 32 can be correctly focused on the data tracks of the optical disc 41 by the lack of focusing errors.

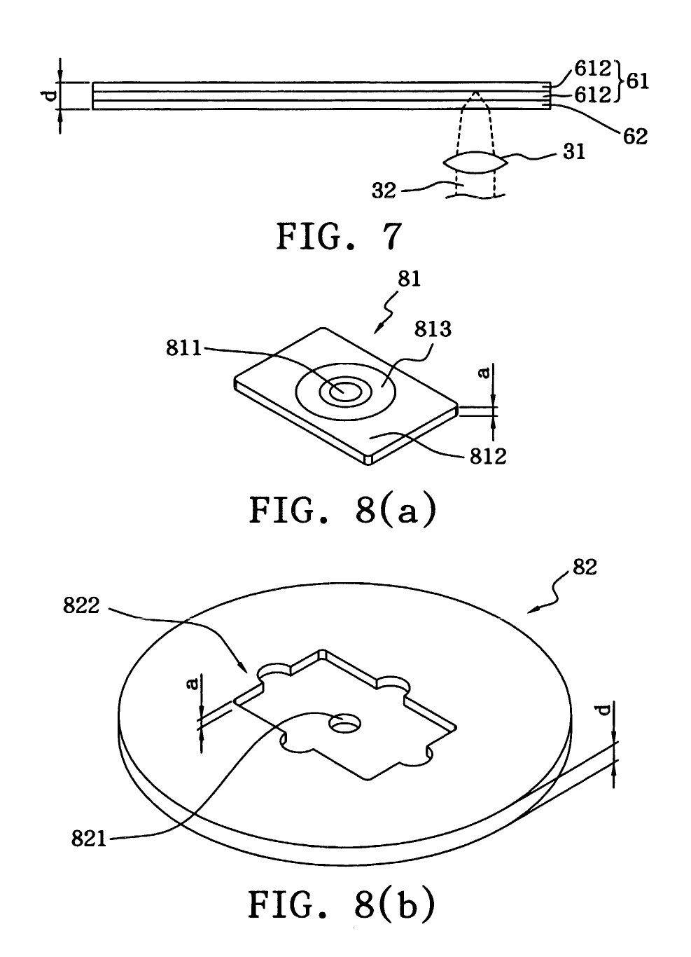

FIG. 6(a) is the cross-sectional diagram of the optical disc in accordance with the present invention, wherein it is an embodiment relating to the modification of conventional digital versatile disc. The digital versatile disc has not only a type of DVD-5 with single readable surface, but also another type of DVD-10 with double readable surface. The embodiment also comprises the applications of both types of digital versatile disc. The optical disc 61 is composed of two layers of PC substrates, including the first PC substrate 612 with the thickness e in 0.39 mm and the second PC substrate 613 with the thickness f in 0.39 mm, which are adhered together, so that the total thickness g is 0.78 mm. There is another auxiliary adapter 62 made of a material like PC substrate 622, with the thickness h in 0.21 mm, as shown in FIG. 6(b). Similarly, the thin-type optical disc 61 is stacked on the upper surface of the auxiliary adapter 62, so that it could play normally after being put together into the optical disc rewriter or player, as shown in FIG. 7. If the data stored on the other surface of the optical disc 61 (DVD-10) needs to be read, only the optical disc 61 is to be reversed and placed on the auxiliary adapter 62. If the optical disc is a type of single readable surface, not a double readable surface, its thickness only needs to be set to that (e or f) of alternative substrate (612 or 613) which contains data tracks at 0.39 mm, and the thickness (e or f) of the another substrate not containing data tracks is still 0.6 mm, so that it could meet the same purpose according to the present invention.

Currently, in the third generation of optical discs, like HD-DVD, the storage capacity for the type of single readable surface is about 20 GB (Gigabyte), and the storage capacity with nm-scale manufacturing technology could reach 1 TB (Terabyte). Nevertheless, optical discs of such high density similarly use the laser beam focused on data tracks for data reading or writing, so that the present invention can still be applied to the optical disc development and have undefined specifications.

The present invention cannot only be applied to common round optical discs, but also to optical discs in the shape of a business card in a wide application range. As shown in FIG. 8(a), a business card optical disc 81 has the thickness a, a <1 mm. Further, there is a round auxiliary adapter 82 with a business card-like concave in the center, wherein the shape and size of the concave 822 is just suitable for embedding the thin-type optical disc 81 and the thickness of the auxiliary adapter 82 is 1.2 mm, as shown in FIG. 8(b). After the reading surface 812 of the business card optical disc 81 is placed downwards in the concave 822, the business card optical disc 81 could be affixed by the concave 822 as to its central hole 811 corresponding to the central hole 821 of the auxiliary adapter 82 without deviation. And, the top surface of the business card optical disc 81 is almost level with the top of the auxiliary adapter 82 to keep the total thickness of the combination the same as that of a general optical disc. In reference to the figure, the auxiliary adapter 82 also has a concave 822 with a deepness a. The optical disc 81 can have a record of personal data, product catalogs, access control security codes, financial accounts, and so on, and therefore it effectively manages and controls the auxiliary adapter 82 and can prevent an unauthorized third party from illegally reading the contents of the business card optical disc 81.

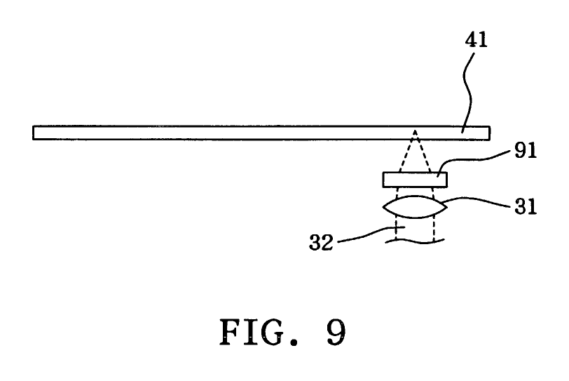

FIG. 9 is a diagram for a preferred embodiment of the thin-type optical disc in accordance with the present invention. A transparent substrate 91 is located between the objective lens and the thin-type optical disc 41, so that the laser beam 32 can be correctly focused on the recording reading layer of the data tracks in the optical disc 41 after refracted by the transparent substrate 91. That is, the transparent substrate 91 and the optical disc 41 are used cooperatively in a non-contacting manner, and an adequate gap is reserved between the two to meet the requirement of correct focusing. The thickness of the transparent substrate 91 is related to the thickness of the optical disk 41, and eventually the data could be normally read from and written on the optical disc 41.

The above-described embodiments of the present invention are intended to give illustrations only. Numerous alternative embodiments may be devised by persons skilled in the art without departing from the scope of the following claims.

What is claimed is:

1. A thin-type optical disc suitable for an optical disc rewriter or player, comprising:
an optical disc having a thickness less than 1 mm; and
an auxiliary adapter stacked on a readable surface of the optical disc;
wherein the total stacked thickness of the auxiliary adapter and the optical disc is adequate for the optical disc rewriter and player for reading data from the optical disc.

2. The thin-type optical disc of claim 1, wherein the total stacked thickness of the auxiliary adapter and the optical disc is from 1.0 mm to 1.6 mm.

3. The thin-type optical disc of claim 1, wherein the shape of the optical disc is a rectangle.

4. The thin-type optical disc of claim 3, wherein a central region of the auxiliary adapter has a concave for containing the optical disc.

5. The thin-type optical disc of claim 1, wherein the auxiliary adapter is made of polycarbonate or cycloolefin copolymer.

6. The thin-type optical disc of claim 1, wherein the auxiliary adapter is made of a transparent substrate.

7. The thin-type optical disc of claim 1, wherein the auxiliary adapter and the optical disc are cooperatively used in a non-contact manner.

8. An optical disc comprising at least one substrate, at least one reflection layer, at least one protection layer and a recording layer, characterized in that:
a. the thickness of the optical disc is less than 1 mm; and
b. the optical disc has to accompany with an auxiliary adapter for use in an optical disc rewriter or player.

9. The optical disc of claim 8, wherein the shape of the optical disc is a rectangle.

10. The optical disc of claim 8, wherein the auxiliary adapter is made of a transparent substrate.
